(19) United States
(12) Patent Application Publication
(10) Pub. No.: US 2024/0310780 A1
(43) Pub. Date: Sep. 19, 2024

(54) LIGHT EMITTING DEVICE AND IMAGE FORMING APPARATUS

(71) Applicant: FUJIFILM Business Innovation Corp., Tokyo (JP)

(72) Inventors: Yosuke KASUYA, Kanagawa (JP); Kento NAKAMURA, Kanagawa (JP)

(73) Assignee: FUJIFILM Business Innovation Corp., Tokyo (JP)

(21) Appl. No.: 18/456,513

(22) Filed: Aug. 27, 2023

(30) Foreign Application Priority Data
Mar. 16, 2023 (JP) 2023-041737

(51) Int. Cl. G03G 21/20

(52) U.S. Cl. CPC G03G 21/206; G03G 2221/1645

(57) ABSTRACT

A light emitting device includes a light emitting unit that generates heat as light is emitted, a support portion that supports the light emitting unit, a heating unit that is disposed close to a surface opposite to the light emitting unit with respect to the support portion and that heats the support portion, an air blowing unit that blows air to the light emitting unit from a heating unit side, and a cover portion that is provided between the heating unit and the air blowing unit and that covers the heating unit against wind caused by the air blowing unit.

### CROSS-REFERENCE TO RELATED APPLICATIONS

This application is based on and claims priority under 35 USC 119 from Japanese Patent Application No. 2023-041737 filed Mar. 16, 2023.

### BACKGROUND

### (i) Technical Field

The present invention relates to a light emitting device and an image forming apparatus.

### (ii) Related Art

Disclosed in JP2008-229908A is an exposure device including a plurality of light emitting elements arranged in a row, a substrate on which the plurality of light emitting elements are disposed, a plurality of temperature measuring units that are disposed along a direction in which the plurality of light emitting elements are arranged and that measure the temperature of the substrate on which the plurality of light emitting elements are disposed, and a plurality of heating units that are disposed along the direction in which the plurality of light emitting elements are arranged and that heat the substrate based on the temperature measured by each of the temperature measuring units.

Disclosed in JP2006-082249A is an image forming apparatus which includes a recording head that exposes a surface of a photoreceptor to light by means of a plurality of light emitting elements, the image forming apparatus including an air blowing device that blows air to the recording head such that the temperature of the recording head is made uniform over the entire length thereof.

Disclosed in JP2020-141019A is a light emitting device including a substrate, a capacitor that is provided on the substrate, a light source that is provided on the substrate and to which a driving electric current is supplied due to electric charge stored in the capacitor, a cover portion through which light emitted by the light source is transmitted and that is disposed in a direction along an optical axis of the light source, and a support portion that is provided on the substrate without being provided in a space between the capacitor and the light source and that supports the cover portion.

Disclosed in JP2021-154535A is a light emitting device including a base extending in one direction, a plurality of light emitting units that are disposed on a surface side of the base to be offset from each other in the one direction and of which a plurality of light sources are supported along the one direction by a support body extending in the one direction, and an air blowing unit that blows air toward the light emitting units via an opening provided in the base.

Disclosed in JP2021-154536A is a light emitting device including a base extending in one direction, a plurality of light emitting units that are disposed on a surface side of the base to be offset from each other in the one direction and of which a plurality of light sources are supported along the one direction by a support body extending in the one direction, a flow path that is disposed on a side opposite to the light emitting units with the base interposed therebetween and through which air is supplied in the one direction, and a wire that is electrically connected to at least one of the plurality of light emitting units and that is disposed in the flow path.

Disclosed in JP2021-154537A is a light emitting device including a base extending in one direction, a plurality of light emitting units that are disposed on a surface side of the base to be offset from each other in the one direction and of which a plurality of light sources are supported along the one direction by a support body extending in the one direction, and a flow path that is disposed on the surface side of the base to surround at least part of the light emitting units and through which air flows along the one direction.

### SUMMARY

As a light emitting device, a light emitting device including a light emitting unit that generates heat as light is emitted, a support portion that supports the light emitting unit, a heating unit that is disposed close to a surface opposite to the light emitting unit with respect to the support portion and that heats the support portion, and an air blowing unit that blows air to the light emitting unit from a heating unit side is conceivable.

In a case where the entire heating unit is exposed to wind caused by the air blowing unit in the light emitting device, the heating unit may be cooled by the wind caused by the air blowing unit.

Aspects of non-limiting embodiments of the present disclosure relate to a light emitting device and an image forming apparatus that restrain a heating unit from being cooled in comparison with a case where the entire heating unit is exposed to wind caused by an air blowing unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an light emitting device including a light emitting unit that generates heat as light is emitted, a support portion that supports the light emitting unit, a heating unit that is disposed close to a surface opposite to the light emitting unit with respect to the support portion and that heats the support portion, an air blowing unit that blows air to the light emitting unit from a heating unit side, and a cover portion that is provided between the heating unit and the air blowing unit and that covers the heating unit against wind caused by the air blowing unit.

### BRIEF DESCRIPTION OF THE DRAWINGS

Exemplary embodiment(s) of the present invention will be described in detail based on the following figures, wherein:

FIG. 1 is a schematic view of an image forming apparatus according to the present exemplary embodiment;

FIG. 2 is a front cross-sectional view of an exposure device according to the present exemplary embodiment;

FIG. 3 is a side cross-sectional view of the exposure device according to the present exemplary embodiment;

FIG. 4 is a plan view of the exposure device according to the present exemplary embodiment;

FIG. 5 is a bottom view of the exposure device according to the present exemplary embodiment in which a first cover portion and a second cover portion are not shown;

FIG. 6 is a bottom view of the exposure device according to the present exemplary embodiment;

FIG. 7 is a block diagram showing a hardware configuration of the exposure device according to the present exemplary embodiment including a control unit;

FIG. 8 is a side cross-sectional view of an exposure device according to a first modification example;

FIG. 9 is a bottom view of the exposure device according to the first modification example;

FIG. 10 is a side cross-sectional view of an exposure device according to a second modification example;

FIG. 11 is a bottom view of the exposure device according to the second modification example; and

FIG. 12 is a schematic view for description of a method of attaching a cover portion in the exposure device according to the second modification example.

### DETAILED DESCRIPTION

An example of an exemplary embodiment according to the present invention will be described below with reference to the drawings.

### Image Forming Apparatus 10

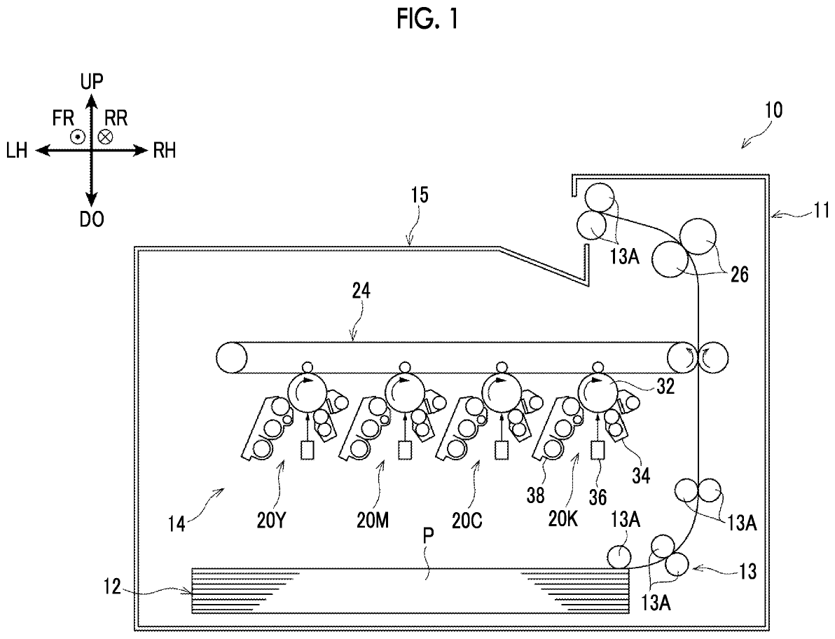

The configuration of an image forming apparatus 10 according to the present exemplary embodiment will be described. FIG. 1 is a schematic view showing the configuration of the image forming apparatus 10 according to the present exemplary embodiment.

Note that an arrow UP shown in the drawing represents a direction to an upper side (more specifically, an upper side in a vertical direction) of the apparatus, and an arrow DO represents a direction to a lower side of the apparatus (specifically, a lower side in the vertical direction). In addition, an arrow LH shown in the drawing represents a direction to a left side of the apparatus and an arrow RH represents a direction to a right side of the apparatus. In addition, an arrow FR shown in the drawing represents a direction to a front side of the apparatus and an arrow RR represents a direction to a rear side of the apparatus. Since these directions are directions determined for the sake of convenience of description, the configuration of the apparatus is not limited by these directions. Note that regarding each of the directions related to the apparatus, the term “apparatus” may be omitted. That is, for example, “the upper side of the apparatus” may simply be described as “the upper side.”

Also, in the following description, the term “vertical direction” may be used to mean “both of an upward direction and a downward direction” or “any one of the upward direction or the downward direction”. A term “right-left direction” may be used to mean “both of a rightward direction and a leftward direction” or “any one of the rightward direction or the leftward direction”. Note that the “right-left direction” may also be referred to as a lateral direction, a transverse direction, and a horizontal direction. A term “front-rear direction” may be used to mean “both of a forward direction and a rearward direction” or “any one of the forward direction or the rearward direction”. Note that the “front-rear direction” may also be referred to as a lateral direction, a transverse direction, and a horizontal direction. In addition, the vertical direction, the right-left direction, and the front-rear direction are directions that intersect each other (specifically, directions orthogonal to each other).

In addition, a symbol in which “x” is in “o” in the drawings means an arrow from the front to the back of the paper surface. In addition, a symbol in which “.” is in “o” in the drawings means an arrow from the back to the front of the paper surface.

The image forming apparatus 10 shown in FIG. 1 is an apparatus that forms an image. Specifically, as shown in FIG. 1, the image forming apparatus 10 includes an apparatus body 11, a medium accommodation portion 12, a medium discharge portion 15, a transport unit 13, and an image forming unit 14. Hereinafter, each part of the image forming apparatus 10 will be described.

### Apparatus Body 11, Medium Accommodation Portion 12, Medium Discharge Portion 15, and Transport Unit 13

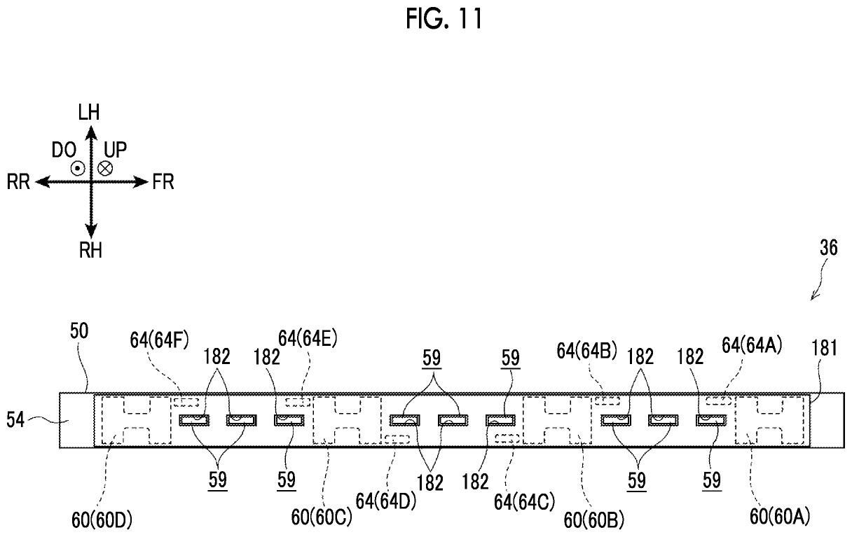

The apparatus body 11 shown in FIG. 11 is a portion in which each component of the image forming apparatus 10 is provided. Specifically, the apparatus body 11 is composed of a housing formed in a box-like shape (for example, a substantially rectangular parallelepiped shape). In the present exemplary embodiment, as shown in FIG. 1, for example, the medium accommodation portion 12, the transport unit 13, and the image forming unit 14 are provided inside the apparatus body 11. The medium discharge portion 15 is formed at an upper surface of the apparatus body 11.

The medium accommodation portion 12 is a portion that accommodates a recording medium P in the image forming apparatus 10. The recording medium P accommodated in the medium accommodation portion 12 is supplied to the image forming unit 14. The recording medium P accommodated in the medium accommodation portion 12 is an object on which an image is formed by the image forming unit 14. Examples of the recording medium P include a paper sheet and a film. Examples of the film include a resin film and a metal film. Note that the recording medium P is not limited to the mediums described above, and various recording mediums can be used.

In the image forming apparatus 10, the medium discharge portion 15 is a portion to which the recording medium P is discharged. The recording medium P on which an image has been formed by the image forming unit 14 is discharged to the medium discharge portion 15.

The transport unit 13 transports, to the medium discharge portion 15, the recording medium P accommodated in the medium accommodation portion 12. Specifically, the transport unit 13 includes transport members 13A such as a plurality of transport rollers and transports the recording medium P by means of the transport members 13A. Note that the transport member 13A may be, for example, a transport member such as a transport belt and a transport drum and various transport members may be used as the transport member 13A.

### Image Forming Unit 14

The image forming unit 14 shown in FIG. 1 is a component that forms an image on the recording medium P transported by the transport unit 13 (specifically, the transport members 13A). The image forming unit 14 forms a toner image (an example of an image) on the recording medium P through an electrophotographic method. Specifically, as shown in FIG. 1, the image forming unit 14 includes toner image forming units 20Y, 20M, 20C, and 20K (hereinafter, 20Y to 20K), a transfer body 24, and a fixing unit 26.

Each of the toner image forming units 20Y to 20K includes a photoreceptor 32. Since the toner image forming units 20Y to 20K are configured in the same manner, reference numerals for each part of the toner image forming units 20Y, 20M, and 20C are omitted in FIG. 1.

The photoreceptor 32 is an example of an image holder, and is a structure that holds a latent image. Specifically, the photoreceptor 32 rotates in one direction (for example, a clockwise direction in FIG. 1). In the vicinity of the photoreceptor 32, a charging device 34, an exposure device 36, and a development device 38 are provided in this order from an upstream side in the direction of rotation of the photoreceptor 32.

In each of the toner image forming units 20Y to 20K, the charging device 34 charges the photoreceptor 32 (a charging step). Furthermore, the exposure device 36 irradiates the charged photoreceptor 32 with light so that an electrostatic latent image is formed on the photoreceptor 32 (an exposure step). The photoreceptor 32 holds the electrostatic latent image formed by the exposure device 36. Then, the development device 38 develops the electrostatic latent image of the photoreceptor 32 so that a toner image is formed (a development step). The specific configuration of the exposure device 36 will be described later.

In the image forming unit 14, the toner image forming units 20Y to 20K perform the charging step, the exposure step, and the development step to form toner images of respective colors which are yellow (Y), magenta (M), cyan (C), and black (K) on the transfer body 24. Furthermore, in the image forming unit 14, the toner images of the respective colors that are formed on the transfer body 24 are transferred to the recording medium P and the toner images are fixed onto the recording medium P by the fixing unit 26. As described above, the image forming unit 14 uses an intermediate transfer method in which an image is transferred to the recording medium P via the transfer body 24.

Note that, as the image forming unit, a direct transfer type image forming unit in which an image is directly transferred to the recording medium P may also be used instead of an intermediate transfer type image forming unit and various image forming units can also be applied.

### Exposure Device 36

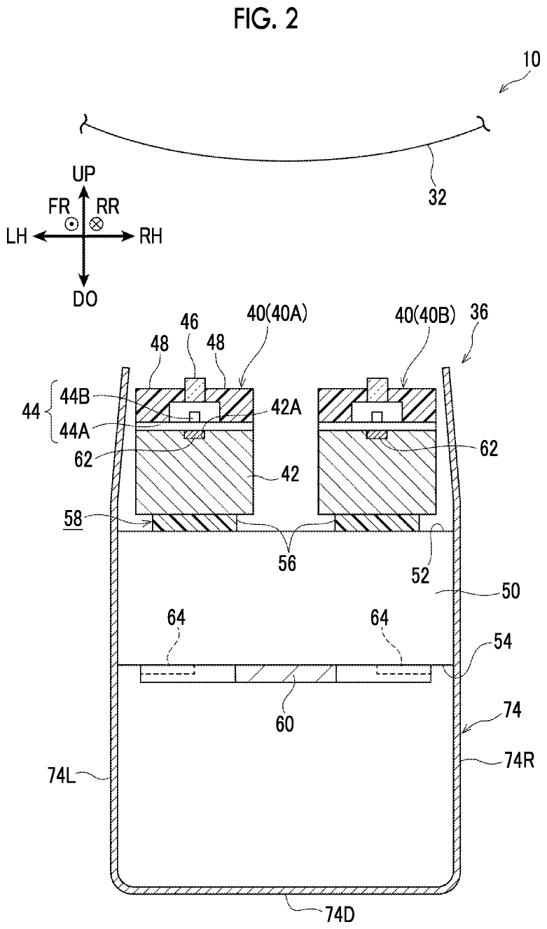

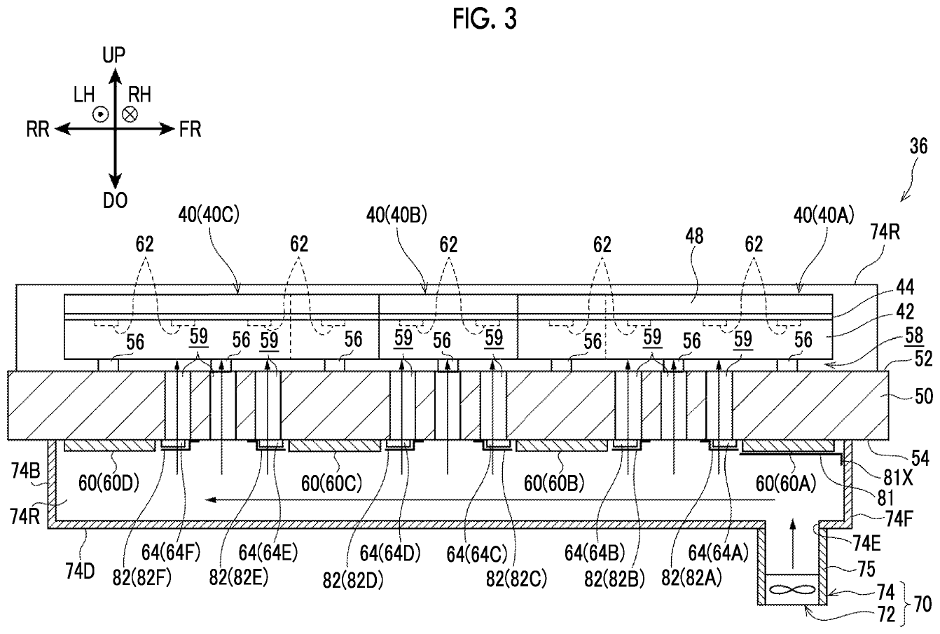

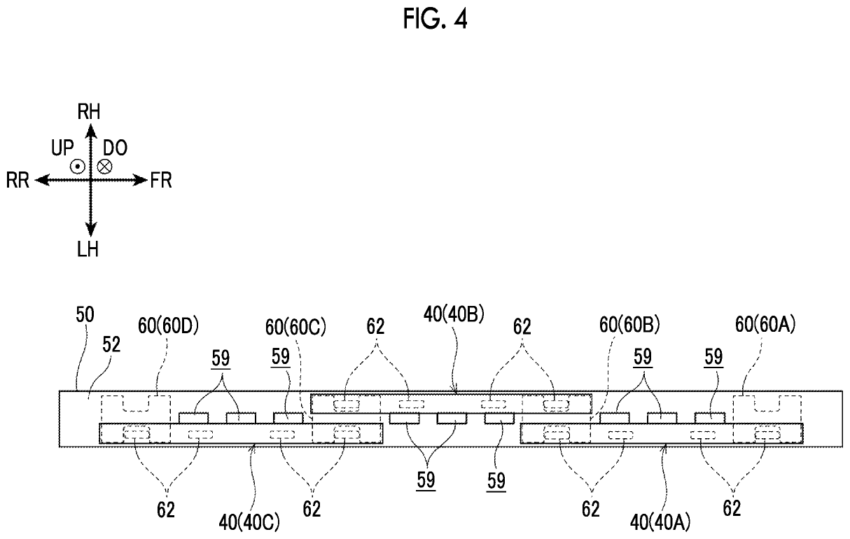

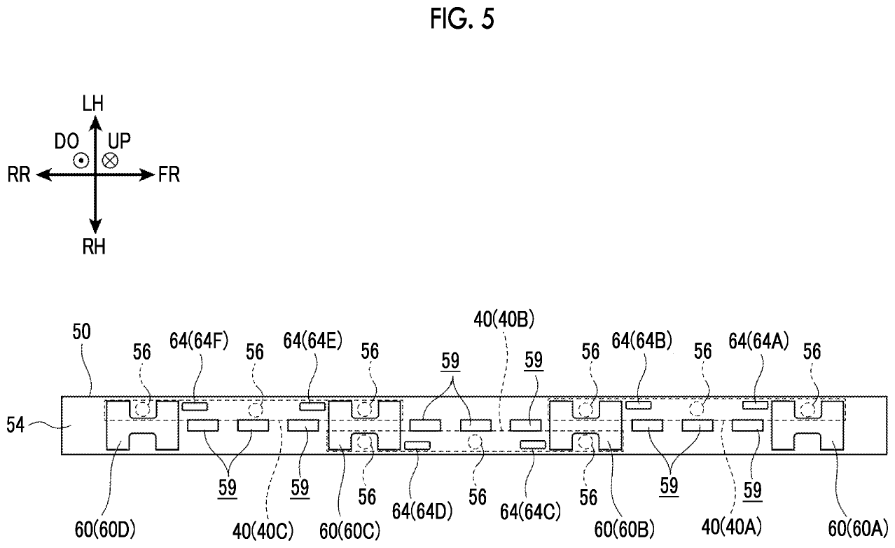

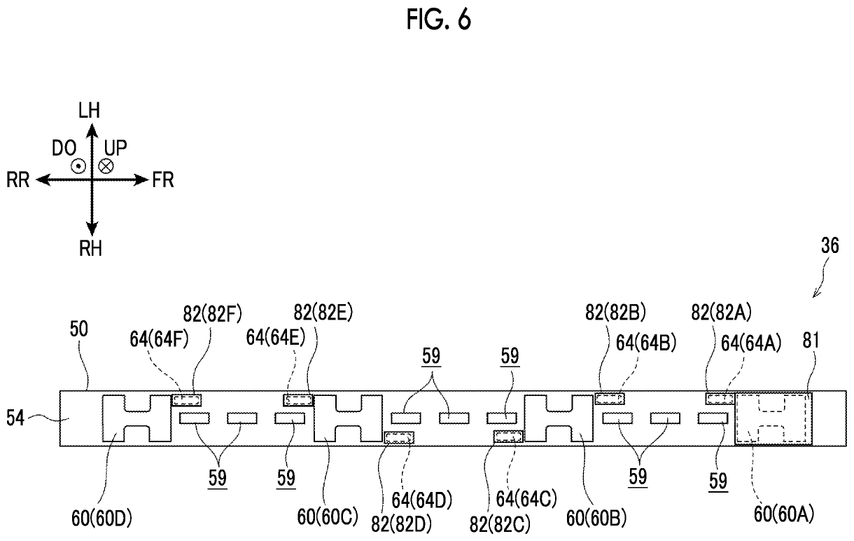

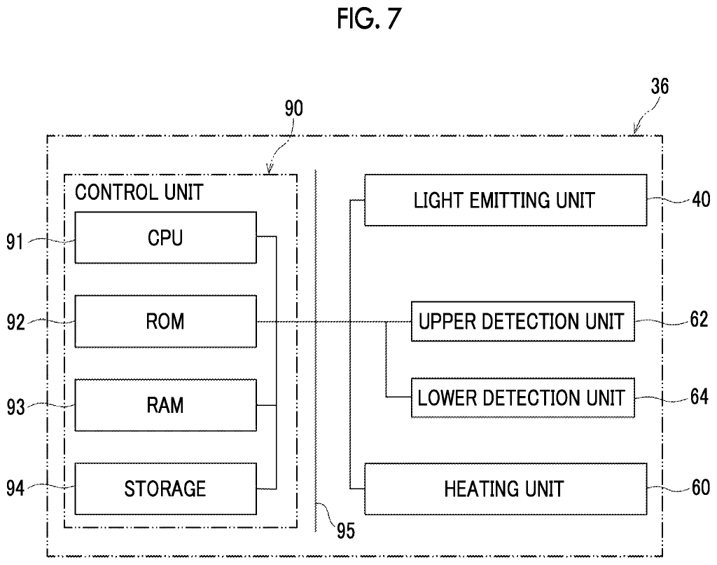

FIG. 2 is a front cross-sectional view of the exposure device 36. FIG. 3 is a side cross-sectional view of the exposure device 36. FIG. 4 is a plan view of the exposure device 36. FIGS. 5 and 6 are bottom views of the exposure device 36. Note that FIG. 5 is a bottom view in which a first cover portion 81 and second cover portions 82, which will be described later, are not shown. FIG. 7 is a block diagram showing a hardware configuration of the exposure device 36 including a control unit 90.

The exposure device 36 shown in FIGS. 2 to 7 is an example of a light emitting device and as described above, the exposure device 36 is a device that irradiates the charged photoreceptor 32 with light so that an electrostatic latent image is formed on the photoreceptor 32. Specifically, as shown in FIGS. 2 to 7, the exposure device 36 includes light emitting units 40, a support portion 50, heating units 60, upper detection units 62, lower detection units 64, the control unit 90, an air blowing unit 70, the first cover portion 81, and the second cover portions 82. Hereinafter, each part of the exposure device 36 will be described.

### Light Emitting Unit 40

The light emitting units 40 shown in FIGS. 2 to 7 are components that emit light and generate heat as the light is emitted. In the present exemplary embodiment, as shown in FIG. 2, the light emitting units 40 are provided above the support portion 50 and irradiate the photoreceptor 32 with light by emitting the light upward.

In addition, as shown in FIG. 4, a plurality of (in the present exemplary embodiment, three) the light emitting units 40 are provided. Each of the three light emitting units 40 (specifically, the light emitting units 40A, 40B, and 40C) is long in the front-rear direction.

The light emitting unit 40A, the light emitting unit 40B, and the light emitting unit 40C are disposed, in a zigzag pattern, in this order in a rearward direction. In the present exemplary embodiment, the light emitting unit 40A and the light emitting unit 40C are disposed on a left side with respect to the light emitting unit 40B. A rear end portion of the light emitting unit 40A is disposed to overlap with a front end portion of the light emitting unit 40B as seen in the right-left direction. A rear end portion of the light emitting unit 40B is disposed to overlap with a front end portion of the light emitting unit 40C as seen in the right-left direction.

The light emitting units 40A, 40B, and 40C are configured in the same manner as each other and as shown in FIGS. 2 and 3, each of the light emitting units 40A, 40B, and 40C includes a base material 42, a light emission substrate 44, a lens unit 46, and a lens holding portion 48.

The base material 42 is a rectangular parallelepiped-shaped block material of which a longitudinal direction is parallel to the front-rear direction. The base material 42 is formed of metal such as stainless steel, for example. As shown in FIG. 2, the base material 42 includes recess portions 42A in which the upper detection units 62 are disposed. A plurality of the recess portions 42A are formed in recess-like shapes open at an upper surface of the base material 42 and are formed to be arranged at intervals along a longitudinal direction of the support portion 50 (the front-rear direction).

The light emission substrate 44 includes a substrate 44A and light sources 44B. The substrate 44A is formed in a plate-like shape of which a thickness direction is parallel to the vertical direction and the substrate 44A extends in the front-rear direction. A plurality of the light sources 44B are disposed on an upper surface of the substrate 44A along the front-rear direction.

Specifically, for example, the light emission substrate 44 is composed of a light emitting element array that includes a semiconductor substrate (an example of the substrate 44A) and a plurality of light emitting elements (an example of the light sources 44B) such as light emitting diodes, light emitting thyristors, and laser elements formed on the semiconductor substrate along the front-rear direction. More specifically, as the light emission substrate 44, a light emission substrate (an example of the light emitting element array) obtained by mounting a surface-emitting semiconductor laser (vertical cavity surface emitting laser (VCSEL)) element on a semiconductor substrate is used. Note that the light emission substrate 44 is not limited to a light emitting element array and may have a configuration including a single light emitting element.

The lens unit 46 is a lens array that is disposed above the light sources 44B of the light emission substrate 44 and that extends in the front-rear direction. The lens unit 46 has a rectangular shape as seen in the front-rear direction, and has a function of causing light emitted from the light sources 44B to be incident onto a lower surface thereof and emitting the light toward a surface of the photoreceptor 32 from an upper surface thereof. The lens unit 46 is disposed at a set relative position with respect to the light sources 44B.

The lens holding portion 48 is disposed on an upper surface of the light emission substrate 44 and holds the lens unit 46 in a state where the lens unit 46 is sandwiched in the right-left direction.

Note that, regarding the device configuration of the exposure device 36, a direction in which the exposure device 36 is not limited to a direction shown in the drawings and the exposure device 36 may be disposed in various directions, as described above. Therefore, the light emitting units 40 may perform irradiation with light in any direction such as an upward direction, a downward direction, a forward direction, a rearward direction, a leftward direction, and a rightward direction.

### Support Portion 50

The support portion 50 shown in FIGS. 2 to 6 is a component that supports the light emitting units 40. In the present exemplary embodiment, as shown in FIGS. 2 to 6, the support portion 50 is composed of a rectangular parallelepiped-shaped block material of which a longitudinal direction is parallel to the front-rear direction. The support portion 50 is formed of metal such as stainless steel.

As shown in FIGS. 2 and 3, the support portion 50 includes an upper surface 52 facing an upper side and a lower surface 54 facing a lower side. The support portion 50 supports the light emitting units 40 via spacers 56 provided on the upper surface 52. The spacers 56 are disposed to be sandwiched between the support portion 50 and the light emitting units 40 in the vertical direction. For example, each of the spacers 56 is formed in a disk-like shape of which an axial direction is parallel to the vertical direction (refer to FIG. 5) and a diameter thereof is smaller than a lateral dimension of the support portion 50. In addition, a plurality of the spacers 56 are disposed to be arranged at intervals along a longitudinal direction of the light emitting units 40 (the front-rear direction). Accordingly, a gap 58 (refer to FIGS. 2 and 3) is formed between the light emitting units 40 and the support portion 50. As described above, the support portion 50 supports the light emitting units 40 on the upper surface 52 side (that is, on the upper side).

In addition, as shown in FIGS. 3 to 6, flow holes 59 through which wind caused by the air blowing unit 70 flows are formed in the support portion 50 along an upward direction. The flow holes 59 penetrate the support portion 50 in a direction from the lower surface 54 to the upper surface 52 and are open at each of the lower surface 54 and the upper surface 52. Note that the “upward direction” is an example of a direction from the heating units 60 to the light emitting units 40.

A plurality of (nine in the present exemplary embodiment) the flow holes 59 are provided. The nine flow holes 59 are disposed at the support portion 50 along the front-rear direction while being disposed between the plurality of heating units 60.

Note that the support portion 50 is not limited to a support portion formed of metal. For example, the support portion 50 may be formed of a resin material. In addition, the support portion 50 is composed of a rectangular parallelepiped-shaped block material, but the present invention is not limited thereto. For example, the support portion 50 may be composed of a metal plate, a resin plate, or the like formed in a plate-like shape.

### Heating Unit 60

The heating units 60 are components that are disposed on the lower surface 54 side of the support portion 50 and that heat the support portion 50. The lower surface 54 is an example of a surface opposite to the light emitting units 40 with respect to the support portion 50.

In the present exemplary embodiment, for example, the heating units 60 are composed of plate-shaped electric heaters that are in contact with the lower surface 54 of the support portion 50 and that heat the lower surface 54 through energization. That is, in the present exemplary embodiment, the heating units 60 heat the support portion 50 from the lower surface 54 side.

In addition, as shown in FIG. 5, a plurality of (in the present exemplary embodiment, four) the heating units 60 are provided. Each of the four heating units 60 (specifically, heating units 60A, 60B, 60C, and 60D) is formed in an approximately H-like shape as seen in the vertical direction. The four heating units 60A, 60B, 60C, and 60D (hereinafter, will be referred to as heating units 60A to 60D) are disposed in this order in the rearward direction while being disposed at intervals.

Each of the four heating units 60A to 60D is disposed to partially overlap with the three light emitting units 40A, 40B, and 40C in the vertical direction. Specifically, a left portion of the heating unit 60A is disposed to overlap with a front end portion of the light emitting unit 40A as seen in the vertical direction. In addition, a left portion of the heating unit 60B is disposed to overlap with the rear end portion of the light emitting unit 40A as seen in the vertical direction. In addition, a right portion of the heating unit 60B is disposed to overlap with the front end portion of the light emitting unit 40B as seen in the vertical direction. In addition, a left portion of the heating unit 60C is disposed to overlap with the front end portion of the light emitting unit 40C as seen in the vertical direction. In addition, a right portion of the heating unit 60C is disposed to overlap with the rear end portion of the light emitting unit 40B as seen in the vertical direction. In addition, a left portion of the heating unit 60D is disposed to overlap with a rear end portion of the light emitting unit 40C as seen in the vertical direction.

### Upper Detection Unit 62 and Lower Detection Unit 64

As shown in FIG. 2, the upper detection units 62 are temperature sensors that are respectively disposed in the plurality of recess portions 42A formed at the base materials 42 of the light emitting units 40 and have a function of detecting the temperatures of the light emitting units 40. That is, the upper detection units 62 detect a temperature on the upper surface 52 side of the support portion 50. In the present exemplary embodiment, as shown in FIG. 4, four upper detection units 62 are disposed for each of the three light emitting units 40.

The lower detection units 64 shown in FIG. 2 are examples of a detection unit and are components that detect the temperature of the support portion 50. Specifically, the lower detection units 64 are temperature sensors disposed on the lower surface 54 of the support portion 50 and have a function of detecting the temperature of the lower surface 54 of the support portion 50. In the present exemplary embodiment, as shown in FIG. 5, a plurality of (in the present exemplary embodiment, six) the lower detection units 64 are provided. The six lower detection units 64 (specifically, lower detection units 64A, 64B, 64C, 64D, 64E, and 64F) are disposed at the support portion 50 along the front-rear direction while being disposed between the plurality of heating units 60. Specifically, the lower detection units 64A and 64B are disposed along the front-rear direction at a left portion of the lower surface 54 of the support portion 50 while being disposed between the heating unit 60A and the heating unit 60B. The lower detection units 64C and 64D are disposed along the front-rear direction at a right portion of the lower surface 54 of the support portion 50 while being disposed between the heating unit 60B and the heating unit 60C. The lower detection units 64E and 64F are disposed along the front-rear direction at the left portion of the lower surface 54 of the support portion 50 while being disposed between the heating unit 60C and the heating unit 60D.

In the present exemplary embodiment, as will be described later, the lower detection units 64 are targets to be covered by the second cover portions 82 and the upper detection units 62 are not the targets to be covered by the second cover portions 82.

### Control Unit 90

FIG. 7 is a block diagram showing a hardware configuration of the exposure device 36 including a control unit 90. Note that, in FIG. 7, for the sake of simplification of the drawing, the light emitting units 40 are collectively shown as one unit, the heating units 60 are collectively shown as one unit, the upper detection units 62 are collectively shown as one unit, and the lower detection units 64 are collectively shown as one unit although the plurality of light emitting units 40, the plurality of heating units 60, the plurality of upper detection units 62, and the plurality of lower detection units 64 are provided in the present exemplary embodiment.

The control unit 90 shown in FIG. 7 is a component that controls the heating units 60 based on the result of detection performed by the upper detection units 62 and the lower detection units 64. In the present exemplary embodiment, the control unit 90 also has a function of controlling the operation of the light emitting units 40.

As shown in FIG. 7, the control unit 90 is connected to the light emitting units 40, the heating units 60, the upper detection units 62, and the lower detection units 64 via a bus 95 such that the control unit 90 can communicate with the light emitting units 40, the heating units 60, the upper detection units 62, and the lower detection units 64. In the present exemplary embodiment, the control unit 90 is configured to include a central processing unit (CPU: processor) 91, a read only memory (ROM) 92, a random access memory (RAM) 93, and a storage 94.

The CPU 91 is a central processing unit and executes various programs or controls each unit. The ROM 92 stores various programs and various data. The RAM 93 temporarily stores a program or data as a work area. The storage 94 is composed of a hard disk drive (HDD) or a solid state drive (SSD) and stores various programs including an operating system and various data.

That is, in the control unit 90, the CPU 91 reads a program from the ROM 92 or from the storage 94 and executes the program by using the RAM 93 as a work area. The CPU 91 performs control of each component and various types of arithmetic processing in accordance with a program stored in the ROM 92 or the storage 94.

In the present exemplary embodiment, the ROM 92 or the storage 94 stores a temperature distribution calculation program used to calculate temperature distribution inside the support portion 50 based on the result of detection of a temperature on the upper surface 52 side of the support portion 50 and a temperature on the lower surface 54 side which is performed by the upper detection units 62 and the lower detection units 64. In addition, the ROM 92 or the storage 94 stores a temperature difference control program that causes, based on the result of the calculation of the temperature distribution calculation program, the heating units 60 to operate such that a temperature difference inside the support portion 50 is made small. Accordingly, a difference between the light emitting units 40 and the support portion 50 in amount of thermal expansion (mainly a positional fluctuation of a joint in a longitudinal direction) is suppressed. Note that in another exemplary embodiment, the ROM 92 or the storage 94 stores a temperature control program that causes, based on the result of the calculation of the temperature distribution calculation program, the heating units 60 to operate such that a temperature inside the support portion 50 reaches a set target temperature. The control unit 90 may have a function of controlling the heating units 60 based on the result of detection performed by the upper detection units 62 and the lower detection units 64 by means of the above-described programs. In this case, thermal expansion of the support portion 50 (mainly a positional fluctuation of a joint in a transverse direction) is suppressed.

### Air Blowing Unit 70

The air blowing unit 70 shown in FIG. 3 is a unit that blows air to the light emitting units 40 from the heating unit 60 side. The air blowing unit 70 includes an air blowing source 72 and a flow pipe 74. The air blowing source 72 is a component that generates wind, and is composed of, for example, an axial air blower. The air blowing source 72 may be an air blower such as a centrifugal air blower (for example, a sirocco fan) as long as the air blowing source 72 is a component that generates wind.

The flow pipe 74 shown in FIG. 3 is a pipe through which wind flows along the lower surface 54 of the support portion 50. Specifically, the flow pipe 74 includes a bottom plate 74D, a left plate 74L (refer to FIG. 2), a right plate 74R, a front plate 74F, a rear plate 74B, and an air blowing pipe 75. In the present exemplary embodiment, the flow pipe 74 and the flow holes 59 formed in the support portion 50 form a flow path through which wind from the air blowing source 72 is sent to the light emitting units 40.

The bottom plate 74D is formed in a plate-like shape of which a thickness direction is parallel to the vertical direction and the bottom plate 74D is disposed along the front-rear direction below the lower surface 54 of the support portion 50. A space serving as a flow path through which wind from the air blowing source 72 flows is provided between the bottom plate 74D and the lower surface 54 of the support portion 50.

As shown in FIG. 2, each of the left plate 74L and the right plate 74R is formed in a plate-like shape of which a thickness direction is parallel to the right-left direction, the left plate 74L and the right plate 74R project upward from a left end portion and a right end portion of the bottom plate 74D respectively, and the left plate 74L and the right plate 74R are disposed along the front-rear direction. The bottom plate 74D, the left plate 74L, and the right plate 74R are integrally formed with each other and have a U-shaped cross section open on the upper side as seen in the front-rear direction. The left plate 74L and the right plate 74R are attached to a left surface and a right surface of the support portion 50 respectively such that the support portion 50 is sandwiched therebetween in the right-left direction.

As shown in FIG. 3, each of the front plate 74F and the rear plate 74B is formed in a plate-like shape of which a thickness direction is parallel to the front-rear direction, and the front plate 74F and the rear plate 74B project upward from a front end portion and a rear end portion of the bottom plate 74D respectively. The front plate 74F and the rear plate 74B are integrally formed with the bottom plate 74D, the left plate 74L, and the right plate 74R. Each of the front plate 74F and the rear plate 74B is in contact with the lower surface 54 of the support portion 50. Accordingly, the space between the bottom plate 74D and the lower surface 54 of the support portion 50 is surrounded by the bottom plate 74D, the left plate 74L, the right plate 74R, the front plate 74F, and the rear plate 74B to be configured as a flow path through which wind from the air blowing source 72 flows along the lower surface 54 of the support portion 50.

An opening 74E is formed in the front end portion of the bottom plate 74D, and an upper end portion of the air blowing pipe 75 is connected to the front end portion of the bottom plate 74D. The air blowing source 72 is disposed at a lower end portion of the air blowing pipe 75, and air from the air blowing source 72 flows from the front side to the rear side between the bottom plate 74D and the lower surface 54 of the support portion 50 after flowing upward in the air blowing pipe 75. The wind flowing from the front side to the rear side between the bottom plate 74D and the lower surface 54 of the support portion 50 flows upward through the plurality of flow holes 59 of the support portion 50 and reaches each of the plurality of light emitting units 40. Accordingly, the plurality of light emitting units 40 are cooled.

### First Cover Portion 81

The first cover portion 81 is an example of a cover portion and as shown in FIGS. 3 and 6, the first cover portion 81 is a component that covers the heating unit 60 against the wind caused by the air blowing unit 70. The meaning of “to cover the heating unit 60 against wind caused by the air blowing unit 70” is to suppress collision between wind generated by the air blowing unit 70 and the heating unit 60. Therefore, the first cover portion 81 does not need to be provided to cover the entire heating unit 60 as long as the provision of the first cover portion 81 reduces the amount of wind colliding with the heating unit 60 in comparison with a case where there is no first cover portion 81. Note that the amount of wind colliding with the heating unit 60 can be checked with a degree to which the temperature of the heating unit 60 is decreased due to the wind.

The first cover portion 81 covers the heating unit 60A, which is one of the plurality of heating units 60 and which is closest to the air blowing source 72 of the air blowing unit 70, against the wind caused by the air blowing unit 70. The first cover portion 81 is provided between the heating unit 60A and the air blowing unit 70 (specifically, the air blowing source 72). Specifically, the first cover portion 81 is disposed at a position that is closer to the heating unit 60A than the air blowing source 72 is and at which the first cover portion 81 overlaps with the heating unit 60A as seen in the vertical direction as shown in FIG. 6. More specifically, the first cover portion 81 overlaps with the entire heating unit 60A as seen in the vertical direction.

In addition, as shown in FIG. 3, the first cover portion 81 is formed in a plate-like shape of which a thickness direction is parallel to the vertical direction and is formed in an approximately rectangular shape as seen in plan view.

The first cover portion 81 does not block the flow holes 59 formed in the support portion 50. That is, the first cover portion 81 leaves openings of the flow holes 59 in the lower surface 54 open so that wind can flow through the flow holes 59. In the present exemplary embodiment, as shown in FIG. 6, the first cover portion 81 is disposed at a position at which the first cover portion 81 does not overlap with the flow holes 59 as seen in the vertical direction.

Furthermore, as shown in FIG. 3, the first cover portion 81 does not come into contact with the heating unit 60A. Specifically, the first cover portion 81 is disposed such that a gap is provided between the first cover portion 81 and the heating unit 60A.

The first cover portion 81 is attached to the flow pipe 74. Specifically, as shown in FIG. 3, the first cover portion 81 includes a projecting portion 81X that projects downward at a front end portion and the projecting portion 81X is attached to the flow pipe 74 by being screwed to the front plate 74F of the flow pipe 74.

### Second Cover Portion 82

As shown in FIGS. 3 and 6, the second cover portions 82 are components that cover the lower detection units 64 against the wind caused by the air blowing unit 70. The meaning of “to cover the lower detection units 64 against wind caused by the air blowing unit 70” is to suppress collision between wind generated by the air blowing unit 70 and the lower detection units 64. Therefore, the second cover portions 82 do not need to be provided to cover the entire lower detection units 64 as long as the provision of the second cover portions 82 reduces the amount of wind colliding with the lower detection units 64 in comparison with a case where there is no second cover portion 82. Note that the amount of wind colliding with the lower detection units 64 can be checked with a degree to which the temperatures of the lower detection units 64 are decreased due to the wind.

A plurality of (in the present exemplary embodiment, six (which is the same number as the number of the lower detection units 64)) the second cover portions 82 are provided. The six second cover portions 82 (specifically, the second cover portions 82A, 82B, 82C, 82D, 82E, and 82F) cover the lower detection units 64A to 64F, respectively. The second cover portions 82A, 82B, 82C, 82D, 82E, and 82F (hereinafter, will be referred to as the second cover portions 82A to 82F) are provided between the lower detection units 64A to 64F and the air blowing unit 70 (specifically, the air blowing source 72), respectively. Specifically, the second cover portions 82A to 82F are respectively disposed at positions that are closer to the lower detection units 64A to 64F than the air blowing source 72 is and at which the second cover portions 82A to 82F overlap with the lower detection units 64A to 64F as seen in the vertical direction as shown in FIG. 6. More specifically, the second cover portions 82A to 82F respectively overlap with the entire lower detection units 64A to 64F as seen in the vertical direction. As described above, in the present exemplary embodiment, the second cover portions 82 cover all of the lower detection units 64 against the wind caused by the air blowing unit 70.

In addition, as shown in FIG. 3, each of the second cover portions 82 is formed in a plate-like shape of which a thickness direction is parallel to the vertical direction and is formed in an approximately rectangular shape as seen in plan view.

In addition, the second cover portions 82 do not block the flow holes 59 formed in the support portion 50. That is, the second cover portions 82 leave the openings of the flow holes 59 in the lower surface 54 open so that wind can flow through the flow holes 59. In the present exemplary embodiment, as shown in FIG. 6, the second cover portions 82 are disposed at positions at which the second cover portions 82 do not overlap with the flow holes 59 as seen in the vertical direction.

Furthermore, as shown in FIG. 3, the second cover portions 82A to 82F do not come into contact with the lower detection units 64A to 64F, respectively. Specifically, the second cover portions 82A to 82F are disposed such that gaps are respectively provided between the second cover portions 82A to 82F and the lower detection units 64A to 64F.

Each of the second cover portions 82A to 82F is attached to the lower surface 54 of the support portion 50. Specifically, for example, each second cover portion 82 is attached to the lower surface 54 of the support portion 50 with one end portion thereof being screwed to the lower surface 54 of the support portion 50.

### Action of Present Exemplary Embodiment

In the present exemplary embodiment, as shown in FIGS. 3 and 6, the first cover portion 81 covers the heating unit 60 against the wind caused by the air blowing unit 70. Here, in a case (hereinafter, referred to as a state A) where the entire heating units 60 are exposed to wind caused by the air blowing unit 70 in the exposure device 36, the heating units 60 may be cooled by the wind caused by the air blowing unit 70.

However, in the present exemplary embodiment, as described above, the first cover portion 81 covers the heating unit 60 against the wind caused by the air blowing unit 70 and thus the heating unit 60 is restrained from being cooled in comparison with the state A. Accordingly, a decrease in temperature adjustment performance of the heating unit 60 with respect to the support portion 50 is suppressed. As a result, exposure inferiority in the exposure device 36 is suppressed and image inferiority in the image forming apparatus 10 is suppressed.

In addition, the first cover portion 81 covers the heating unit 60A, which is one of the plurality of heating units 60 and which is closest to the air blowing source 72 of the air blowing unit 70, against the wind caused by the air blowing unit 70.

Therefore, heating unevenness of the plurality of heating units 60 is suppressed in comparison with a case where the first cover portion 81 covers only the heating unit 60D, which is one of the plurality of heating units 60 and which is farthest from the air blowing source 72 of the air blowing unit 70, against the wind caused by the air blowing unit 70.

In addition, in the present exemplary embodiment, the first cover portion 81 does not block the flow holes 59 formed in the support portion 50. Therefore, the light emitting units 40 are cooled by the wind caused by the air blowing unit 70 and an increase in temperature of the light emitting units 40 is suppressed in comparison with a case where the first cover portion 81 blocks the flow holes 59.

In addition, in the present exemplary embodiment, the first cover portion 81 does not come into contact with the heating unit 60A. Therefore, thermal conduction between the heating unit 60A and the first cover portion 81 is suppressed in comparison with a case where the first cover portion 81 comes into contact with the heating unit 60A. As a result, the heating unit 60A is restrained from being cooled.

In addition, in the present exemplary embodiment, the first cover portion 81 is attached to the flow pipe 74. Therefore, it is easy to adjust a distance between the heating unit 60A disposed on the lower surface 54 of the support portion 50 and the first cover portion 81 in comparison with a case where the first cover portion 81 is attached to the support portion 50. In other words, according to the present configuration, the degree of freedom in the disposition position of the first cover portion 81 is high.

In addition, in the present exemplary embodiment, the second cover portions 82 cover the lower detection units 64 against the wind caused by the air blowing unit 70. Therefore, the lower detection units 64 are restrained from being cooled in comparison with a case where the entire lower detection units 64 are exposed to the wind caused by the air blowing unit 70.

In addition, in the present exemplary embodiment, the second cover portions 82 cover all of the lower detection units 64 against the wind caused by the air blowing unit 70. Therefore, all of the lower detection units 64 are restrained from being cooled in comparison with a case where the second cover portions 82 cover only part of the lower detection units 64.

In addition, in the present exemplary embodiment, the second cover portions 82 do not block the flow holes 59 formed in the support portion 50. Therefore, the light emitting units 40 are cooled by the wind caused by the air blowing unit 70 and an increase in temperature of the light emitting units 40 is suppressed in comparison with a case where the second cover portions 82 block the flow holes 59.

In addition, in the present exemplary embodiment, the second cover portions 82A to 82F do not come into contact with the lower detection units 64A to 64F, respectively. Therefore, thermal conduction between the lower detection units 64A to 64F and the respective second cover portions 82A to 82F is suppressed in comparison with a case where the second cover portions 82A to 82F come into contact with the lower detection units 64A to 64F, respectively. As a result, the lower detection units 64A to 64F are restrained from being cooled.

### First Modification Example

In the present exemplary embodiment, the first cover portion 81 covers the heating unit 60A, which is one of the plurality of heating units 60 and which is closest to the air blowing source 72 of the air blowing unit 70, against the wind caused by the air blowing unit 70. However, the present invention is not limited thereto.

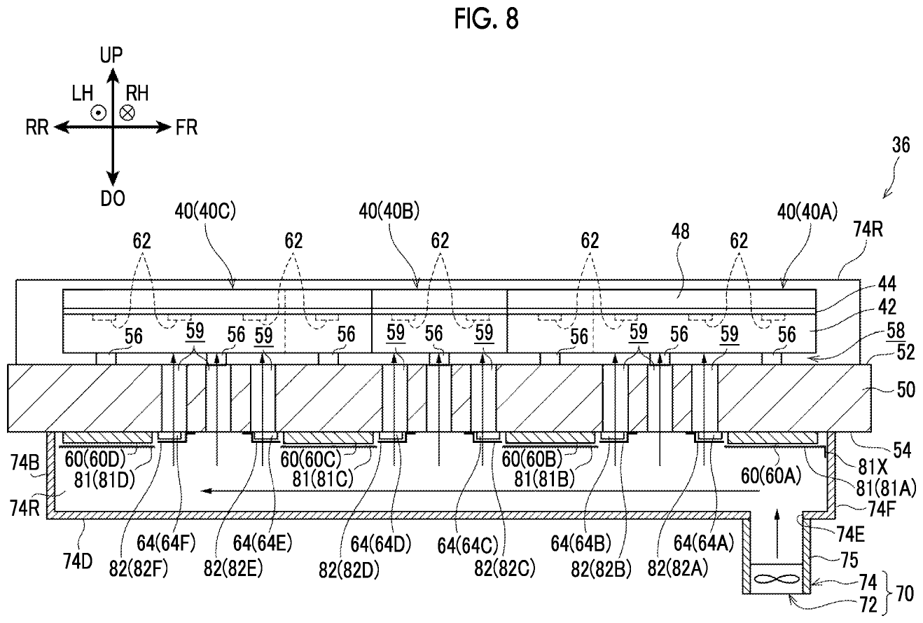

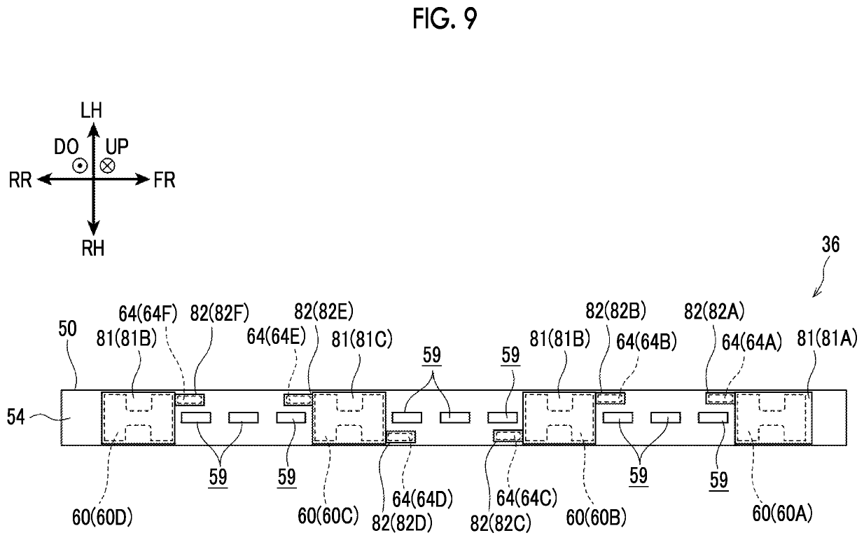

In a first modification example, as shown in FIGS. 8 and 9, a plurality of (in the present exemplary embodiment, four (which is the same number as the number of the heating units 60)) the first cover portions 81 are provided. The four first cover portions 81 (specifically, the first cover portions 81A, 81B, 81C, and 81D) cover the heating units 60A to 60D, respectively. The first cover portions 81A, 81B, 81C, and 81D (hereinafter, will be referred to as the first cover portions 81A to 81D) are provided between the heating units 60A to 60D and the air blowing unit 70 (specifically, the air blowing source 72), respectively.

Specifically, the first cover portions 81A to 81D are respectively disposed at positions that are closer to the heating units 60A to 60D than the air blowing source 72 is and at which the first cover portions 81A to 81D overlap with the heating units 60A to 60D as seen in the vertical direction as shown in FIG. 8. Furthermore, specifically, the first cover portions 81A to 81D respectively overlap with the entire heating units 60A to 60D as seen in the vertical direction.

As described above, in the first modification example, the first cover portions 81 cover all of the heating units 60 including the heating unit 60D, which is one of the plurality of heating units 60 and which is farthest from the air blowing source 72 of the air blowing unit 70, against the wind caused by the air blowing unit 70.

Note that the first cover portions 81B and 81C are attached to, for example, the flow pipe 74 (for example, any of the left plate 74L and the right plate 74R). In addition, the first cover portion 81D is attached to, for example, the flow pipe 74 (for example, any of the left plate 74L, the right plate 74R, and the rear plate 74B).

### Action of First Modification Example

In the first modification example, the first cover portions 81 cover all of the heating units 60 including the heating unit 60D, which is one of the plurality of heating units 60 and which is farthest from the air blowing source 72 of the air blowing unit 70, against the wind caused by the air blowing unit 70.

Therefore, all of the heating units 60 are restrained from being cooled in comparison with a case where the first cover portions 81 cover only part of the heating units 60.

### Second Modification Example

In the first modification example, the number of the first cover portions 81 provided is the same as the number of the heating units 60 and the plurality of first cover portions 81 cover the plurality of heating units 60 respectively. However, the present invention is not limited thereto.

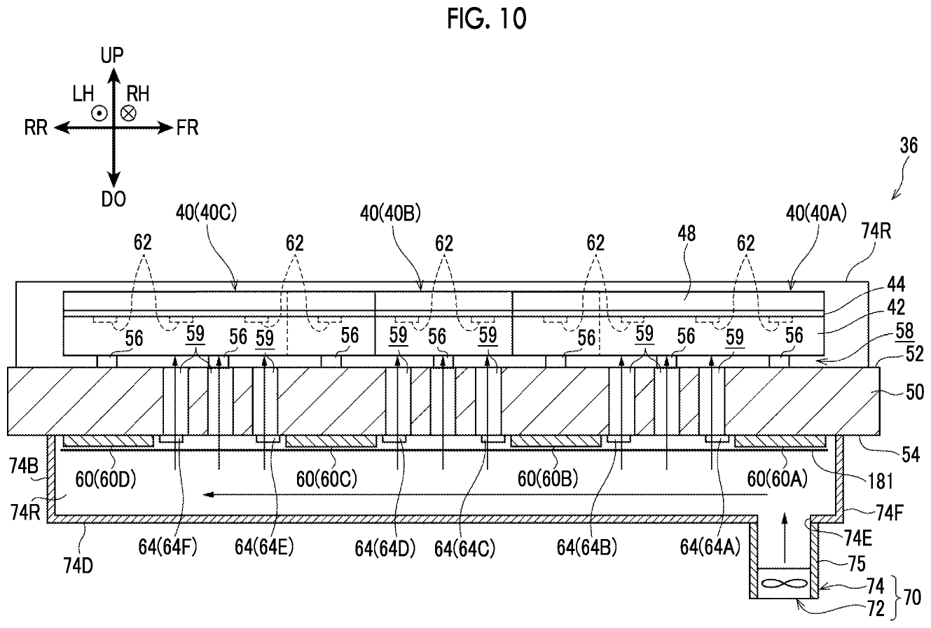

In a second modification example, as shown in FIGS. 10 and 11, a cover portion 181, which is composed of a single member that covers all of the heating units 60 against the wind caused by the air blowing unit 70, is provided. The cover portion 181 is an example of a first cover portion and an example of a second cover portion.

The cover portion 181 is also a single member that covers all of the lower detection units 64 against the wind caused by the air blowing unit 70. As described above, in the second modification example, the cover portion 181 which is obtained by integrally forming the second cover portion with the first cover portion covers all of the heating units 60 and all of the lower detection units 64 against the wind caused by the air blowing unit 70.

The cover portion 181 is provided between all of the heating units 60, all of the lower detection units 64, and the air blowing unit 70 (specifically, the air blowing source 72). Specifically, as shown in FIG. 11, the cover portion 181 is disposed at a position at which the cover portion 181 overlaps with all of the heating units 60 and all of the lower detection units 64 as seen in the vertical direction. More specifically, the cover portion 181 completely overlaps with all of the heating units 60 and all of the lower detection units 64 as seen in the vertical direction.

In addition, as shown in FIG. 10, the cover portion 181 is formed in a plate-like shape of which a thickness direction is parallel to the vertical direction and is formed in an approximately rectangular shape as seen in plan view.

The cover portion 181 does not block the flow holes 59 formed in the support portion 50. Specifically, as shown in FIG. 11, notches 182 that overlap with the flow holes 59 in the vertical direction are formed in the cover portion 181. Specifically, the notches 182 are composed of holes extending along outer edges of the flow holes 59 and the diameter thereof is equal to the diameter of the flow holes 59 or larger than the diameter of the flow holes 59. Accordingly, the cover portion 181 leaves the openings of the flow holes 59 in the lower surface 54 open so that wind can flow through the flow holes 59.

Furthermore, as shown in FIG. 10, the cover portion 181 does not come into contact with all of the heating units 60 and all of the lower detection units 64. Specifically, the cover portion 181 is disposed such that a gap is provided between the cover portion 181, all of the heating units 60, and all of the lower detection units 64.

In addition, the cover portion 181 is attached to the support portion 50 in an upward direction and is movable in the right-left direction. The “upward direction” is an example of a direction from the heating units 60 to the light emitting units 40. The “right-left direction” is an example of a direction intersecting the direction from the heating units 60 to the light emitting units 40.

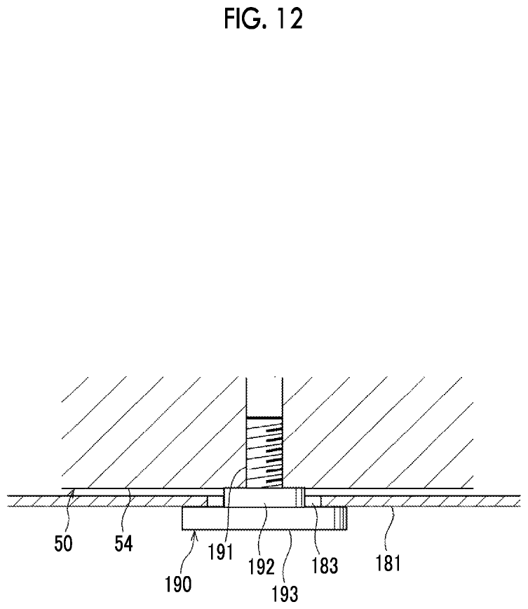

Specifically, as shown in FIG. 12, the cover portion 181 is attached to the support portion 50 by means of a stepped screw 190. The stepped screw 190 includes a shaft portion 191, an intermediate portion 192, and a head portion 193.

The shaft portion 191 has a columnar shape, and a screw thread to be screwed upward with respect to the support portion 50 is formed on an outer periphery thereof. The intermediate portion 192 is provided at one end portion (a lower end portion in FIG. 12) of the shaft portion 191, has a columnar shape, and has a diameter larger than the diameter of the shaft portion 191. An outer peripheral surface of the intermediate portion 192 is a cylindrical surface without a screw thread. The head portion 193 is provided on a side opposite to the shaft portion 191 with respect to the intermediate portion 192 (a lower side in FIG. 12) and has a diameter larger than the diameter of the intermediate portion 192.

A through hole 183 that has an inner diameter larger than the outer diameter of the intermediate portion 192 and smaller than the outer diameter of the head portion 193 is formed in the cover portion 181. In a state where the intermediate portion 192 is in the through hole 183, the shaft portion 191 of the stepped screw 190 is screwed upward with respect to the support portion 50 so that the cover portion 181 is attached to the support portion 50. In addition, for example, the cover portion 181 has a thickness smaller than the axial length of the intermediate portion 192.

As shown in FIG. 12, in a state where the cover portion 181 is attached by means of the stepped screw 190, the cover portion 181 is disposed between the lower surface 54 of the support portion 50 and the head portion 193 of the stepped screw 190 with the intermediate portion 192 of the stepped screw 190 being in the through hole 183.

Note that although movement of the cover portion 181 in the vertical direction is restricted by the lower surface 54 of the support portion 50 and the head portion 193 of the stepped screw 190, a gap corresponding to a dimensional difference between the thickness of the cover portion 181 and the axial length of the intermediate portion 192 is formed between the cover portion 181, the lower surface 54 of the support portion 50, and the head portion 193 of the stepped screw 190. In addition, although movement of the cover portion 181 in the right-left direction is restricted by the intermediate portion 192 of the stepped screw 190, the cover portion 181 can move in the right-left direction within an area corresponding to a dimensional difference between the inner diameter of the through hole 183 and the outer diameter of the shaft portion 191. Therefore, in the second modification example, the cover portion 181 is attached to the support portion 50 in a state where the cover portion 181 is movable in the right-left direction.

### Action of Second Modification Example

In the second modification example, as described above, the cover portion 181, which is composed of a single member, covers all of the heating units 60 against the wind caused by the air blowing unit 70. Therefore, the number of components is reduced in comparison with a case where the cover portion individually covers each of all of the heating units 60.

In addition, in the second modification example, as described above, the cover portion 181, which is composed of a single member, covers all of the lower detection units 64 against the wind caused by the air blowing unit 70. Therefore, the number of components is reduced in comparison with a case where the cover portion individually covers each of all of the lower detection units 64.

Furthermore, in the second modification example, as described above, the cover portion 181 which is obtained by integrally forming the second cover portion with the first cover portion covers all of the heating units 60 and all of the lower detection units 64 against the wind caused by the air blowing unit 70. Therefore, the number of components is reduced in comparison with a case where the second cover portion is formed separately from the first cover portion. In addition, in the second modification example, the cover portion 181 is attached to the support portion 50 in an upward direction and is movable in the right-left direction. Therefore, deformation of the support portion 50 or the cover portion 181 in the case of expansion of the support portion 50 in the right-left direction is suppressed in comparison with a case where the cover portion 181 is attached in a state of being not movable in the right-left direction.

### Other Modification Examples

In the above-described exemplary embodiment, the first cover portion 81 covers the heating unit 60A, which is one of the plurality of heating units 60 and which is closest to the air blowing source 72 of the air blowing unit 70, against the wind caused by the air blowing unit 70. However, the present invention is not limited thereto. In addition, in the first modification example, the first cover portions 81 cover all of the heating units 60 against the wind caused by the air blowing unit 70. However, the present invention is not limited thereto. Furthermore, in the second modification example, the cover portion 181 covers all of the heating units 60 against the wind caused by the air blowing unit 70. However, the present invention is not limited thereto. The first cover portion 81 and the cover portion 181 may be configured to cover any one of the plurality of heating units 60 or two or more of the plurality of heating units 60, for example. Therefore, the first cover portion 81 and the cover portion 181 may be configured to cover only the heating unit 60D, which is one of the plurality of heating units 60 and which is farthest from the air blowing source 72 of the air blowing unit 70, against the wind caused by the air blowing unit 70. That is, the first cover portion 81 and the cover portion 181 only need to be configured to cover at least one heating unit 60 against the wind caused by the air blowing unit 70.

In addition, in the above-described exemplary embodiment, the first cover portion 81 does not come into contact with the heating unit 60A. However, the present invention is not limited thereto. In addition, in the second modification example, the cover portion 181 does not come into contact with all of the heating units 60. However, the present invention is not limited thereto. For example, the first cover portion 81 and the cover portion 181 may be configured to come into contact with the heating unit 60.

In addition, in the above-described exemplary embodiment, the second cover portions 82 cover the lower detection units 64 against the wind caused by the air blowing unit 70. However, the present invention is not limited thereto. For example, a configuration in which the second cover portions 82 are not provided and the entire lower detection units 64 are exposed to the wind caused by the air blowing unit 70 may also be adopted.

In addition, in the above-described exemplary embodiment, the second cover portions 82 cover all of the lower detection units 64 against the wind caused by the air blowing unit 70. However, the present invention is not limited thereto. For example, a configuration in which the second cover portions 82 cover only part of the lower detection units 64 may also be adopted.

In addition, in the above-described exemplary embodiment, the second cover portions 82A to 82F do not come into contact with the lower detection units 64A to 64F, respectively. However, the present invention is not limited thereto. The second cover portions 82 may be configured to come into contact with the lower detection units 64.

In addition, in the above-described exemplary embodiment and the first modification example, the first cover portion 81 is attached to the flow pipe 74. However, the present invention is not limited thereto. The first cover portion 81 may be configured to be attached to the support portion 50 or the heating unit 60, for example.

In addition, in the above-described exemplary embodiment, the second cover portions 82 are attached to the lower surface 54 of the support portion 50. However, the present invention is not limited thereto. For example, the second cover portion 82 may be configured to be attached to the flow pipe 74 or the heating unit 60, for example.

In addition, in the second modification example, the cover portion 181 is attached to the lower surface 54 of the support portion 50. However, the present invention is not limited thereto. For example, the cover portion 181 may be configured to be attached to the flow pipe 74 or the heating unit 60, for example.

In addition, an attachment method in the second modification example in which the cover portion 181 is attached to the support portion 50 by means of the stepped screw 190 can be adopted for a case where the cover portion 181 is attached to the flow pipe 74 or the heating unit 60 and a case where the first cover portion 81 and the second cover portions 82 are attached to any of the support portion 50, the flow pipe 74, and the heating unit 60. In this case, the various covering portions (that is, the first cover portion 81, the second cover portion 82, and the cover portion 181) are attached to an attachment target to be movable along an attachment surface of the attachment target.

In addition, in the second modification example, the cover portion 181 covers all of the heating units 60 and all of the lower detection units 64 against the wind caused by the air blowing unit 70. However, the present invention is not limited thereto. For example, a configuration in which a cover portion that covers all of the heating units 60 against the wind caused by the air blowing unit 70 and a cover portion that covers all of the lower detection units 64 against the wind caused by the air blowing unit 70 are provided may also be adopted. In addition, a configuration in which a cover portion that collectively covers part (for example, the heating unit 60A) of the plurality of heating units 60 and part (for example, the lower detection unit 64A) of the plurality of lower detection units 64 is provided may also be adopted.

The present invention is not limited to the above-described exemplary embodiment, and various modifications, changes, and improvements can be made without departing from the scope of the present invention. For example, the above-described modification examples may be combined with each other as appropriate.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))
A light emitting device comprising:
a light emitting unit that generates heat as light is emitted;
a support portion that supports the light emitting unit;
a heating unit that is disposed close to a surface opposite to the light emitting unit with respect to the support portion and that heats the support portion;
an air blowing unit that blows air to the light emitting unit from a heating unit side; and
a cover portion that is provided between the heating unit and the air blowing unit and that covers the heating unit against wind caused by the air blowing unit.
(((2)))
The light emitting device according to (((1))),
wherein a plurality of the heating units are provided, and
the cover portion covers at least a heating unit, which is one of the plurality of heating units and which is closest to an air blowing source of the air blowing unit, against the wind caused by the air blowing unit.
(((3)))
The light emitting device according to (((2))),
wherein the cover portion covers all of the heating units against the wind caused by the air blowing unit.
(((4)))
The light emitting device according to (((3))),
wherein the cover portion is composed of a single member that covers all of the heating units against the wind caused by the air blowing unit.
(((5)))
The light emitting device according to any one of (((1))) to (((4))),
wherein a flow hole through which the wind caused by the air blowing unit flows is formed in the support portion along a direction from the heating unit to the light emitting unit, and
the cover portion does not block the flow hole.
(((6)))
The light emitting device according to any one of (((1))) to (((5))),
wherein the cover portion does not come into contact with the heating unit.
(((7)))
The light emitting device according to (((6))),
wherein the air blowing unit includes a flow pipe through which wind flows along the surface, and
the cover portion is attached to the flow pipe.
(((8)))
The light emitting device according to any one of (((1))) to (((7))),
wherein the cover portion is attached to the support portion or the heating unit in a direction from the heating unit to the light emitting unit and is movable in a direction intersecting the direction from the heating unit to the light emitting unit.
(((9)))
The light emitting device according to any one of (((1))) to (((8))),
wherein a first cover portion as the cover portion is provided,
a detection unit that detects a temperature of the support portion is provided,
a control unit that controls the heating unit based on a result of detection performed by the detection unit is provided, and
a second cover portion that is provided between the detection unit and the air blowing unit and that covers the detection unit against the wind caused by the air blowing unit is provided.
(((10)))
The light emitting device according to (((9))),
wherein a plurality of the detection units are provided, and
the second cover portion covers all of the detection units against the wind caused by the air blowing unit.
(((11)))
The light emitting device according to (((10))),
wherein the second cover portion is composed of a single member that covers all of the detection units against the wind caused by the air blowing unit.
(((12)))
The light emitting device according to any one of (((9))) to (11))),
wherein a flow hole through which the wind caused by the air blowing unit flows is formed in the support portion along a direction from the heating unit to the light emitting unit, and
the second cover portion does not block the flow hole.
(((13)))
The light emitting device according to any one of (((9))) to (((12))),
wherein the second cover portion does not come into contact with the detection unit.
(((14)))
The light emitting device according to any one of (((9))) to (((13))),
wherein the second cover portion is attached to the support portion or the heating unit in a direction from the heating unit to the light emitting unit and is movable in a direction intersecting the direction from the heating unit to the light emitting unit.
(((15)))
The light emitting device according to any one of (((9))) to (((14))),
wherein the second cover portion is integrally formed with the first cover portion.
(((16)))
An image forming apparatus comprising:
an image holder;
the light emitting device according to any one of (((1))) to (((15))) that irradiates the image holder in a charged state with light so that an electrostatic latent image is formed; and
a development device that develops the electrostatic latent image on the image holder so that an image is formed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light emitting device comprising:
a light emitting unit that generates heat as light is emitted;
a support portion that supports the light emitting unit;
a heating unit that is disposed close to a surface opposite to the light emitting unit with respect to the support portion and that heats the support portion;
an air blowing unit that blows air to the light emitting unit from a heating unit side; and
a cover portion that is provided between the heating unit and the air blowing unit and that covers the heating unit against wind caused by the air blowing unit.

2. The light emitting device according to claim 1,
wherein a plurality of the heating units are provided, and
the cover portion covers at least a heating unit, which is one of the plurality of heating units and which is closest to an air blowing source of the air blowing unit, against the wind caused by the air blowing unit.

3. The light emitting device according to claim 2,
wherein the cover portion covers all of the heating units against the wind caused by the air blowing unit.

4. The light emitting device according to claim 3,
wherein the cover portion is composed of a single member that covers all of the heating units against the wind caused by the air blowing unit.

5. The light emitting device according to claim 1,
wherein a flow hole through which the wind caused by the air blowing unit flows is formed in the support portion along a direction from the heating unit to the light emitting unit, and
the cover portion does not block the flow hole.

6. The light emitting device according to claim 1,
wherein the cover portion does not come into contact with the heating unit.

7. The light emitting device according to claim 6,
wherein the air blowing unit includes a flow pipe through which wind flows along the surface, and
the cover portion is attached to the flow pipe.

8. The light emitting device according to claim 1,
wherein the cover portion is attached to the support portion or the heating unit in a direction from the heating unit to the light emitting unit and is movable in a direction intersecting the direction from the heating unit to the light emitting unit.

9. The light emitting device according to claim 1,
wherein a first cover portion as the cover portion is provided,
a detection unit that detects a temperature of the support portion is provided,
a control unit that controls the heating unit based on a result of detection performed by the detection unit is provided, and
a second cover portion that is provided between the detection unit and the air blowing unit and that covers the detection unit against the wind caused by the air blowing unit is provided.

10. The light emitting device according to claim 9,
wherein a plurality of the detection units are provided, and
the second cover portion covers all of the detection units against the wind caused by the air blowing unit.

11. The light emitting device according to claim 10,
wherein the second cover portion is composed of a single member that covers all of the detection units against the wind caused by the air blowing unit.

12. The light emitting device according to claim 9,
wherein a flow hole through which the wind caused by the air blowing unit flows is formed in the support portion along a direction from the heating unit to the light emitting unit, and
the second cover portion does not block the flow hole.

13. The light emitting device according to claim 9,
wherein the second cover portion does not come into contact with the detection unit.

14. The light emitting device according to claim 9,
wherein the second cover portion is attached to the support portion or the heating unit in a direction from the heating unit to the light emitting unit and is movable in a direction intersecting the direction from the heating unit to the light emitting unit.

15. The light emitting device according to claim 9,
wherein the second cover portion is integrally formed with the first cover portion.

16. An image forming apparatus comprising:
an image holder;
the light emitting device according to claim 1 that irradiates the image holder in a charged state with light so that an electrostatic latent image is formed; and
a development device that develops the electrostatic latent image on the image holder so that an image is formed.

17. An image forming apparatus comprising:
an image holder;
the light emitting device according to claim 2 that irradiates the image holder in a charged state with light so that an electrostatic latent image is formed; and
a development device that develops the electrostatic latent image on the image holder so that an image is formed.

18. An image forming apparatus comprising:
an image holder;
the light emitting device according to claim 3 that irradiates the image holder in a charged state with light so that an electrostatic latent image is formed; and
a development device that develops the electrostatic latent image on the image holder so that an image is formed.

19. An image forming apparatus comprising:
an image holder;
the light emitting device according to claim 4 that irradiates the image holder in a charged state with light so that an electrostatic latent image is formed; and
a development device that develops the electrostatic latent image on the image holder so that an image is formed.

20. An image forming apparatus comprising:
an image holder,
the light emitting device according to claim 5 that irradiates the image holder in a charged state with light so that an electrostatic latent image is formed; and
a development device that develops the electrostatic latent image on the image holder so that an image is formed.
